(19) United States
(12) Patent Application Publication
(10) Pub. No.: US 2014/0097151 A1
(43) Pub. Date: Apr. 10, 2014

(54) METHOD OF FORMING A TRANSPARENT CONDUCTIVE LAYER ON A SUBSTRATE

(71) Applicant: FAR EASTERN NEW CENTURY CORPORATION, TAIPEI (TW)

(72) Inventors: HSIN-KAI LAI, TAIPEI (TW); CHIH YUAN TSENG, TAIPEI (TW); HUI SHAN TSAI, TAIPEI (TW)

(21) Appl. No.: 14/043,921

(22) Filed: Oct. 2, 2013

(30) Foreign Application Priority Data
Oct. 5, 2012 (TW) 101137013

(51) Int. Cl. H01B 13/30

(52) U.S. Cl. CPC H01B 13/30
USPC 216/13

(57) ABSTRACT

The present invention provides a method of forming a transparent conductive layer on a substrate, including: applying a conductive composition containing a conductive polymer onto the substrate to form the transparent conductive layer thereon, forming a patterned protection layer on the transparent conductive layer to define a transparent conductive layer region covered by the protection layer and a transparent conductive layer region not covered by the protection layer; performing a wet etching process on the transparent conductive layer region not covered by the protection layer; and removing the protection layer, wherein an annealing process is performed on the transparent conductive layer before or after the wet etching process. The method of the present invention can reduce the chromatic aberration between the etched transparent conductive layer and the un-etched transparent conductive layer. Moreover, since the present invention does not utilize an additional optical layer to eliminate the chromatic aberration, the method of the present invention would be simpler and more economically attractive compared to the conventional ones.

### BACKGROUND OF THE INVENTION

1. Field of the Invention

The present invention relates to a method of forming a transparent conductive layer on a substrate.

2. Description of the Related Art

Touch panels are becoming an increasingly widespread mechanism for convenient signal input on electronic products. Rapid developments in touch technology have led to adoption of optical, ultrasonic, electrostatic capacitive, and resistive film touch panels, among other types, depending on the method used to detect position. Resistive/electrostatic capacitive touch panels are made of a transparent conductive layer and a glass sheet separated by a spacer. Depending on the needs addressed, the transparent conductive layer may need to be patterned. Lithography and etching are the technologies generally applied to pattern a transparent conductive layer. However, etching produces a difference in thickness between the etched and un-etched parts of the transparent conductive layer, and can damage the electrical properties of the conductive layer. The optical properties (such as absorption and reflection) of the transparent conductive layer are affected both by the difference in thickness and the damage to electrical property, resulting in obvious chromatic aberration and other defects in appearance. Such defects are especially concerning due to the location of the transparent conductive layer at the light-incident side of an electrostatic capacitive touch panel.

In an existing technology for manufacturing a transparent conductive film through dry sputtering of indium tin oxide (ITO), a solution has been proposed to solve the above defects, in which the optical properties are improved by forming at least one primer between a transparent conductive layer and a substrate (ROC Patent No. I346046). Nevertheless, this method needs a primer.

Other techniques of forming a transparent conductive layer have been disclosed. For example, Japanese Patent 4364938 and Japanese Patent Laid-Open 2011-17795 disclose a method of forming a transparent conductive layer through dry sputtering; and Japanese Patent Laid-Open 2011-44145, Japanese Patent Laid-Open 2003-80624, and U.S. Pat. No. 7,083,851 disclose a method of forming a transparent conductive layer through wet coating. In these patents, an additional optical layer is required to solve the chromatic aberration problem caused by the resulting thickness differences in an etched transparent conductive layer (for example, two optical layers d1 and d2 are used). However, such techniques increase the difficulty of the manufacturing process while conferring only limited improvement of appearance. in addition, a conductive film made of ITO is fragile and incurs high manufacturing costs.

Recent improvements to electrical properties and processability of conductive polymers have heightened attention to their economical advantages.

US 2011/0059232 discloses a method of forming a transparent organic electrode using an organic conductive composition containing poly-3,4-ethylenedioxythiophene) (PEDOT)/polystyrene sulfonate (PSS); and Agfa proposes a patterning method using lithography and etching for a conductive polymer (Adv. Mater. 2006, 18, 1307-1312 and Macromol. Rapid Commun. 2005, 26, 238-246). Nevertheless, when a conductive polymer is applied on a transparent conductive layer, the problem of chromatic aberration from thickness differences in the transparent conductive layer (for example, caused by etching used for patterning) can still occur, along with undesirable product appearance. Although there are many existing techniques for adjusting the refractive index of an optical film by adding an optical layer, for example, an optical cement (OCA cement), so as to mitigate the chromatic aberration problem due to circuitry patterning, such technologies require additional procedures in the manufacturing process. Moreover, there is room for further improvement of optical properties.

Therefore, there remains a demand in the industry for a method to improve the formation of a transparent conductive layer.

### SUMMARY OF THE INVENTION

One objective of the present invention is to provide a method of forming a transparent conductive layer on a substrate to solve at least one of the foregoing problems. Specifically, one objective of the present invention is to provide a method of mitigating the chromatic aberration problem caused by the patterning of a transparent conductive layer without adding an optical layer.

According to the present invention, the method of forming a transparent conductive layer on a substrate comprises: applying a conductive composition containing a conductive polymer onto a substrate to form a transparent conductive layer on the substrate; forming a patterned protection layer on the transparent conductive layer to define a transparent conductive layer region covered by the protection layer and a transparent conductive layer region not covered by the protection layer; performing a wet etching process to the transparent conductive layer region not covered by the protection layer; and removing the protection layer, where an annealing process is performed on the transparent conductive layer before or after the wet etching process.

The method of forming a transparent conductive layer according to the present invention can reduce chromatic aberration between a transparent conductive layer and neighboring regions, specifically, reduce the conventional chromatic aberration caused. because of the changes of the optical properties (such as absorption and reflection) produced by the thickness difference of the transparent conductive layer. in addition, because the method of the present invention does not need an additional optical layer to reduce the chromatic aberration, the method of the present invention would be simpler and more economically attractive.

### BRIEF DESCRIPTION OF THE DRAWINGS

The invention will be described according to the drawings in which:

FIG. 1A to FIG. 1B show a method of forming a transparent conductive layer according to an embodiment of the present invention.

### DETAILED DESCRIPTION OF THE INVENTION

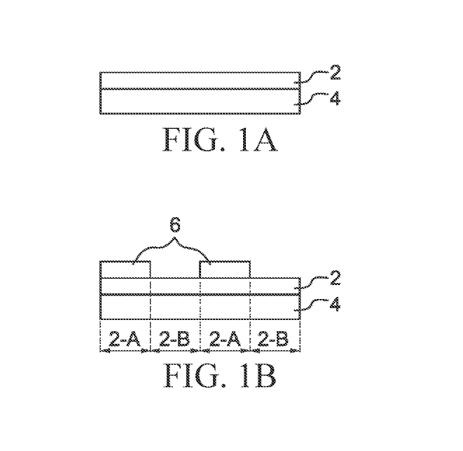

The following describes a method of forming a transparent conductive layer according to a specific embodiment of the present invention. through FIG. 1A to FIG. 1B.

As shown in FIG. 1A, a conductive composition containing a conductive polymer is applied on a substrate 4 to form a transparent conductive layer 2 thereon.

The conductive polymer used in the present invention may be formed by a monomer selected from a group consisting of pyrrole, thiophene, aniline and a mixture thereof, and a derivative thereof, an oligomer selected from a group consisting of pyrrole, thiophene, aniline and a mixture thereof and a derivative thereof, or a combination of any of the forgoing.

The “oligomer” recited herein has the general meaning known in the technical field of the present invention, for example, referring to a compound composed of a limited number of the above monomers. For example, it may refer to a dimer, trimer, tetramer or pentamer of a monomer that may produce a conductive polymer.

The “derivative of the monomer” recited herein has the general meaning known in the technical field of the present invention. For example, it may refer to a substituted. monomer of the forgoing.

The “derivative of the oligomer” recited herein has the general meaning known in the technical field of the present invention. For example, it may refer to a substituted oligomer of the forgoing.

For example, “pyrrole” and “the derivative of the pyrrole” both refer to a monomer that may be polymerized into a conductive polymer having a structure to that of pyrrole.

The derivative of the pyrrole that may be used in the present invention, for example, includes, but not limited to: 3-alkylpyrrole, such as 3-hexylpyrrole; 3,4-dialkylpyrrole, such as 3,4-dihexylpyrrole; 3-alkoxypyrrole, such as 3-methoxypyrrole; and 3,4-dialkoxypyrrole, such as 3,4-dimethoxypyrrole.

The derivative of the thiophene that may be used in the present invention, for example, includes, but not limited to: 3,4-ethylenedioxythiophene and a derivative thereof; 3-alkylthiophene, such as 3-hexylthlophene; and 3-alkoxythiophene, such as 3-methoxythiophene.

The derivative of the aniline that may be used in the present invention, for example, includes, but not limited to: 2-alkylaniline, such as 2-methylaniline; and 2-alkoxyaniline, such as 2-methoxyaniline.

According to the specific embodiments of the present invention, the used monomer is 3,4-ethylenedioxythiophene (EDOT) or a derivative thereof, for example, including, but not limited to: 3,4-(1-alkyl)ethylenedioxythiophene, such as 3,4-(1-hexyl)ethylenedioxythiophene. In this case, the conductive composition of the present invention may further include polystyrene sulfonate (PSS) to match with the PEDOT.

The amount of the conductive polymer used in the method of the present invention is not specifically limited. However, in order to obtain acceptable conductivity, the amount of the conductive polymer in the composition is about 1% to about 50% by weight, and is preferably about 20% to about 30% by weight.

The conductive composition according to the present invention may include a solvent. The solvent that may be used in the present invention is (preferably selected from the solvent that has an acceptable compatible effect with the conductive polymer. The solvent may be water (preferably deionized water), an organic solvent or an organic solvent mixed with water. The organic solvent includes: alcohol, such as methanol, ethanol and isopropyl alcohol (IPA); the aromatic hydrocarbon, such as benzene, methylbenzene and dimethylbezene; aliphatic hydrocarbon, such as hexane; and the aprotic polar solvent, such as N,N-dimethylformamide, dimethyl sulfoxide, acetonitrile and acetone. The foregoing solvents may be used alone or in combination. The foregoing solvent preferably comprises at least one of water, an alcoholic organic solvent and an aprotic polar solvent, and the preferred choices include water, ethanol, dimethyl sulfoxide, a mixture of water and IPA, a mixture of ethanol and water and a mixture of dimethyl sulfoxide and water.

The conductive composition of the present invention may comprise an adhesive to improve the adhesive force of the conductive composition of the present invention. The applicable adhesive is known in the technical field of the present invention, for example, including, but not limited to: a water-soluble low molecular weight adhesive, a water-soluble high molecular weight adhesive or a combination thereof.

The conductive composition of the present invention may comprise a viscosity modifier to adjust the viscosity of the conductive composition of the present invention, so that the conductive composition is suitable to be applied on a substrate through printing. If the viscosity of the conductive composition is too high or too low, the conductive composition is not suitable to be applied on the substrate through printing. The viscosity modifier is selected according to the method of the printing selected. The conductive composition may be printed by, for example, inkjet printing, screening printing, intaglio printing and lithographic printing. Depending on the printing method selected, which viscosity modifier that might be applicable is known in the technical field of the present invention.

The conductive composition of the present invention may comprise a conductivity enhancer to improve the conductivity of the transparent conductive layer of the present invention. The applicable conductivity enhancer can be the one known in the technical field of the present invention, such as dimethyl sulfoxide.

The conductive composition of the present invention may comprise a stabilizer to improve the stability of the transparent conductive layer. The applicable stabilizer can be the one known in the technical field of the present invention, such as tannic acid, gallic acid or a combination thereof.

The material of the substrate 4 is not specifically limited, and the substrate may be made of any material, as long as the transparent conductive layer can be easily formed thereon. In addition, the substrate 4 may comprise an element known in other technical fields of the present invention, such as a measurement element used to measure the change of capacitance when a user touches a touch panel with hands, an electrode wire or an optical layer, and the like. If the substrate of the present invention further comprises an optical layer, the transparent conductive layer of the present invention may be formed thereon. Depending on the application thereof, the substrate 4 may be made of a colored or colorless material. When the substrate 4 is used as a display plane of a display device, the substrate 4 may be made of a transparent material. For example, the substrate 4 may be made of polyethylene terephthalate (PET), polycarbonate, polymethyl methacrylate, polyethylene naphthalate (PEN), polyether sulfone (PES), cyclic olefin polymer (COC) and the like, glass, tempered glass and the like.

According to the present invention, transparency may include colorless and transparent, colored and transparent, translucent, colored and translucent, and the like.

The conductive composition may be applied on the substrate 4 by any method known in the technical field of the present invention, for example, by coating or printing. According to one specific aspect of the present invention, the conductive composition is applied on the substrate 4 through coating, for example, through spin coating, bar coating, dip coating, slot coating, roll to roll coating, and the like, which is not limited.

Referring to FIG. 1B, FIG. 1B shows that one patterned protection layer 6 is formed on the transparent conductive layer 2 to define a transparent conductive layer region 2-A covered by the protection layer and a transparent conductive layer region 2-B not covered by the protection layer. The transparent conductive layer region 2-B not covered by the protection layer is an exposed part of the transparent conductive layer to be subsequently etched to damage the electrical properties.

The protection layer 6 may be applied on the transparent conductive layer 2 by any method known in the technical field of the present invention, for example, through coating or printing. According to a specific aspect of the present invention, the protection layer 6 is applied on the transparent conductive layer 2 by a printing method, and is then patterned in a manner known in the technical field of the present invention, for example, through optical lithography and etching. Alternatively, a patterned protection layer 6 is formed directly on the transparent conductive layer 2 through printing (for example, by screen printing).

The material of the protection layer may be obtained in a manner known in the technical field of the present invention. For example, it may be purchased from H.C. Starck GmbH, Goslar (trade name, Clevios SET G, thermosetting acryl resin).

According to one embodiment of the present invention, a chemical etching may be performed on the transparent conductive layer not covered by the protection layer. A wet etching process may be performed thereon to damage the electrical properties of the transparent conductive layer, so that the surface impedance thereof is larger than about 80 MΩ and is preferably larger than about 100 MΩ. The etchant used is known in the technical field of the present invention, for example, including, but not limited to, an aqueous solution of NaClO₃, an aqueous solution of KMnO₄, and the like.

After the protection layer is removed, the patterned transparent conductive layer is exposed, an annealing process is performed on the patterned transparent conductive layer, where the annealing process comprises: performing a heat treatment at a constant temperature within a temperature range between about 65° C. and about 165° C., and preferably between about 80° C. and about 150° C. for about 0.5 to about 2 hours and preferably for over about 1 hour, then cooling to the room temperature through natural cooling. In addition, after the step of removing the protection layer, a step of washing the surface of the transparent conductive layer using an acid may be further comprised. For example, the surface of the transparent conductive layer can be washed by using H₂SO₄. This step of acid washing may be performed before the annealing process.

According to another embodiment of the present invention, the annealing process may be performed before the chemical etching (wet etching) process. For example, after the transparent conductive layer is formed and before the protection layer is formed thereon, the annealing process is performed on the transparent conductive layer that is not patterned. The annealing process comprises: performing a heat treatment at a constant temperature within a temperature range between about 65° C. and about 165° C., and preferably between about 80° C. and 150° C. for about 0.5 to about 2 hours and preferably for over about 1 hour, and then cooling to the room temperature through natural cooling.

Subsequently, the patterned protection layer is formed on the transparent conductive layer, and the chemical etching is performed on the transparent conductive layer not covered by the protection layer. A wet etching process is performed thereon to damage the electrical properties of the transparent conductive layer, so that the surface impedance thereof is larger than about 80 MΩ and is preferably larger than about 100 MΩ. The method of forming the patterned protection layer and the method of performing chemical etching are as discussed above.

The following examples are hereby used to describe the present invention, rather than limit the present invention.

### EXAMPLES

### Example 1

0.13 g of tannic acid is dissolved in 20 g of 0.5% conductive aqueous solution of PEDOT:PSS (the aqueous solution containing 25% of IPA, the manufacturer, Starck GmbH, Goslar), and then a number 9 coil bar is used to coat the formula liquid on the PET substrate (Toyobo A4300) to form a transparent conductive layer thereon. Next, the protection layer circuitry (Clevios SET G, the manufacturer, H.C. Starck GmbH, Goslar) is printed on the transparent conductive layer through screen printing, and then an etchant (5% aqueous solution of NaClO₃) is used to damage the electrical properties of the conductive layer (the surface impedance >100 MΩ). Subsequently, 1.5% NH₄OH is used to remove the protection layer, and 1% H₂SO₄ acid is used to wash the surface of the conductive layer, and then the substrate is placed in a high temperature oven of about 150° C. for 1 hour. Next, the substrate is taken out and cooled to the room temperature through natural cooling. Through comparison with the result of a blank test in which no high-temperature thermal process is performed, the result is as follows:

| | | | | | | | Δb* of | ΔE* of |
|---|---|---|---|---|---|---|---|---|
| | | Thermal | Etching | | | | Regions | Regions |
| | | treatment | Process | L* | a* | b* | A and B | A and B |
| Blank | Region A | X | X | 96.64 | −1.32 | 0.52 | 1.29 | 1.979 |
| | Region B | X | ◯ | 95.14 | −1.26 | −0.77 | | |
| Example 1 | Region A | ◯ | X | 93.27 | −0.28 | −0.22 | 0.25 | 1.112 |
| | Region B | ◯ | ◯ | 94.13 | 0.38 | −0.47 | | |

L*, a* and b⁴ (CIELAB) are used to describe three basic coordinates of the color model of all colors visible to human eyes, and represent the brightness of the colors (L*, L*=0 refers to black and L*=100 refers to white), the position between red/magenta and green (the negative value of a* represents green while the positive value of a* represents magenta), and the position between yellow and blue (the negative value of b* represents blue while the positive value of b* represents yellow), respectively.

The uniform change in the L*a*b* model corresponds to the uniform change in the perceptual colors. Therefore, the relative perceptual difference between any two colors in L*a*b* can he approximated by processing each color as one point in a three-dimensional space (three components: L*, a*, b*), and the Euclidean distance ΔE (generally referred to as “Delta E”) between them is calculated.

ΔE*=[(ΔL*)²+(Δa*)²+(Δb*)²]^{1/2}

### Example 2

Except that the etchant is 5% Clevios etch manufactured by H.C. Starck GmbH, Goslar, the reaction process and the conditions thereof are those applied in Example 1.

The result is as follows:

| | | | | | | | Δb* of | ΔE* of |
|---|---|---|---|---|---|---|---|---|
| | | Thermal | Etching | | | | Regions | Regions |
| | | Treatment | Process | L* | a* | b* | A and B | A and B |
| Blank | Region A | X | X | 94.39 | −0.6 | −0.9 | 0.51 | 0.730 |
| | Region B | X | ◯ | 94.91 | −0.66 | −1.41 | | |
| Example 2 | Region A | ◯ | X | 93.51 | −0.21 | −0.1 | 0.35 | 0.474 |
| | Region B | ◯ | ◯ | 93.19 | −0.2 | 0.25 | | |

### Example 3

Except that the etchant is the 10% Clevios etch, the reaction process and the conditions thereof are those applied in Example 2. The result is as follows:

| | | | | | | | Δb* of | ΔE* of |
|---|---|---|---|---|---|---|---|---|
| | | Thermal | Etching | | | | Regions | Regions |
| | | Treatment | Process | L* | a* | b* | A and B | A and B |
| Blank | Region A | X | X | 94.57 | −0.89 | −0.62 | 0.51 | 0.724 |
| | Region B | X | ◯ | 95.08 | −0.96 | −1.13 | | |
| Example 3 | Region A | ◯ | X | 93.58 | −0.24 | −0.14 | 0.17 | 0.443 |
| | Region B | ◯ | ◯ | 93.18 | −0.15 | 0.03 | | |

### Example 4

Except that the transparent conductive layer is placed in the oven of 80° C. for 1 to hour, the reaction process and the conditions thereof are those applied in Example 3.

### Example 5

Except that the transparent conductive layer is placed in the oven of 80° C. for 240 hours, the reaction process and the conditions thereof are those applied in Example 3.

| | | | | | | | Δb* of | ΔE* of |
|---|---|---|---|---|---|---|---|---|
| | | Thermal | Etching | | | | Regions | Regions |
| | | Treatment | Process | L* | a* | b* | A and B | A and B |
| Blank | Region A | X | X | 94.57 | −0.89 | −0.62 | 0.51 | 0.724 |
| | Region B | X | ◯ | 95.08 | −0.96 | −1.13 | | |
| Example 3 | Region A | ◯ | X | 93.58 | −0.24 | −0.14 | 0.171 | 0.443 |
| (150° C., | Region B | ◯ | ◯ | 93.18 | −0.15 | 0.03 | | |
| 1 hour) | | | | | | | | |
| Example 4 | Region A | ◯ | X | 93.47 | −0.69 | −0.44 | 0.46 | 0.720 |
| (80° C., | Region B | ◯ | ◯ | 93.28 | −0.17 | 0.02 | | |
| 1 hour) | | | | | | | | |
| Example 5 | Region A | ◯ | X | 93.52 | −0.32 | −0.15 | 0.18 | 0.465 |
| (80° C., | Region B | ◯ | ◯ | 93.13 | −0.14 | 0.03 | | |
| 240 hours) | | | | | | | | |

### Example 6

0.13 g of tannic acid is dissolved in 20 g of 0.5% conductive aqueous solution of PEDOT:PSS (the aqueous solution containing 25% of WA, the manufacturer, H.C. Starck GmbH, Goslar), and then a number 9 coil bar is used to coat the formula liquid on the PET substrate (Toyobo A4300) to form a transparent conductive layer thereon. The substrate is placed in a high temperature oven of about 150° C. for 1 hour, then the substrate is taken out and cooled to the room temperature through natural cooling to complete the annealing process. Next, the protection layer circuitry (Clevios SET G, the manufacturer H.C. Starck GmbH, Goslar) is printed on the transparent conductive layer through screen printing, and then an etchant (5% Clevios etch) is used to damage the electrical properties of the conductive layer (the surface impedance>100 MΩ). After that, 1.5% NH₄OH is used to remove the protection layer, and 1% H₂SO₄ acid is used to wash the surface of the conductive layer. The result is as follows:

| | | | | | | | Δb* of | ΔE* of |
|---|---|---|---|---|---|---|---|---|
| | | Thermal | Etching | | | | Regions | Regions |
| | | Treatment | Process | L* | a* | b* | A and B | A and B |
| Example 2 | Region A | ◯ | X | 93.51 | −0.21 | −0.1 | 0.35 | 0.474 |
| | Region B | ◯ | ◯ | 93.19 | −0.2 | 0.25 | | |
| Example 6 | Region A | ◯ | X | 93.78 | −0.64 | −0.22 | 0.08 | 0.13 |
| | Region B | ◯ | ◯ | 93.67 | −0.6 | −0.16 | | |

By comparing Example 6 with Example 2, it can be found that if the annealing process is performed before the etching process, Δb* and ΔE* can be effectively lowered, that is, the chromatic aberration problem of the transparent conductive layer can be mitigated. Therefore, a better effect can be achieved by performing the annealing process after the etching process.

### Comparative Example 1

0.13 g of tannic acid is dissolved in 20 g of 0.5% conductive aqueous solution to of PEDOT:PSS (the aqueous solution containing 25% of IPA, the manufacturer H.C. Starck GmbH, Goslar), and then a number 9 coil bar is used to coat the formula liquid on the PET substrate (Toyobo A4300) to form a transparent conductive layer thereon. Next, after the circuitry is etched with laser, the substrate is placed in a high temperature oven of about 150° C. for 1 hour. The result is as follows:

| | | Etch- | | | | | |
|---|---|---|---|---|---|---|---|
| | Thermal | ing | | | | Δb* of | ΔE* of |
| | Treat- | Pro- | | | | Regions | Regions |
| | ment | cess | L* | a* | b* | A and B | A and B |
| Re- | X | X | 94.8015 | −0.4612 | 0.1798 | 0.732 | 1.927 |
| gion A | | | | | | | |
| Re- | X | ◯ | 96.5511 | −0.1111 | 0.910 | | |
| gion B | | | | | | | |
| Re- | ◯ | X | 94.8015 | −0.4612 | 0.1798 | 0.799 | 1.963 |
| gion A | | | | | | | |
| Re- | ◯ | ◯ | 96.5711 | −0.1721 | 0.9788 | | |
| gion C | | | | | | | |

For use in the specification of the subject application, X (thermal treatment) indicates that the region does not undergo a thermal treatment; O (thermal treatment) indicates that the region undergoes a thermal treatment; X (etching process) indicates that region does not undergo an etching process to damage the electrical properties of the transparent conductive layer; and O (etching process) indicates that the region undergoes an etching process to damage the electrical properties of the transparent conductive layer.

It can be found from the comparative example that the present invention is not applicable to physical/dry etching.

It can be seen from the above results, which are obtained by comparing the blank tests where no annealing process is performed with the method of the present invention, that the method of the present invention can effectively lower Δb* and ΔE*. That is, the chromatic aberration problem of a transparent conductive layer is mitigated. In addition, the method of the present invention does not require an additional optical layer, so the problem of an undesirable appearance caused by the patterning of a transparent conductive layer is mitigated, and the producing process thereof would be simpler and more economical.

What is claimed is:

1. A method of forming a transparent conductive layer on a substrate, comprising:
applying a conductive composition containing a conductive polymer onto a substrate to form a transparent conductive layer on the substrate;
forming a patterned protection layer on the transparent conductive layer to define a transparent conductive layer region covered by the protection layer and a transparent conductive layer region not covered by the protection layer;
performing a wet etching process on the transparent conductive layer region not covered by the protection layer; and
removing the protection layer,
wherein an annealing process is performed on the transparent conductive layer before or after the wet etching process.

2. The method according to claim 1, wherein the conductive composition is applied on the substrate through coating or printing.

3. The method according to claim 2, wherein the coating is selected from a group consisting of: spin coating, bar coating, dip coating, slot coating and roll to roll coating.

4. The method according to claim 1, wherein the patterned protection layer is formed on the transparent conductive layer through screen printing.

5. The method according to claim 1, wherein the step of performing a wet etching process on the transparent conductive layer not covered by the protection layer makes the surface impedance of the transparent conductive layer not covered by the protection layer be larger than about 80 MΩ.

6. The method according to claim 1, wherein the step of performing a wet etching process on the transparent conductive layer not covered by the protection layer makes the surface impedance of the transparent conductive layer not covered by the protection layer be larger than about 100 MΩ.

7. The method according to claim 1, wherein after the step of removing the protection layer, the surface of the transparent conductive layer is washed using H₂SO₄.

8. The method according to claim 1, wherein the annealing process comprises: performing treatment at a constant temperature within a temperature range between about 65° C. and about 165° C. for about 0.5 to about 2 hours, and then performing cooling to the room temperature.

9. The method according to claim 1, wherein the annealing process comprises: performing treatment at a constant temperature within a temperature range between about 80° C. and about 150° C. for about 0.5 to about 2 hours, and then performing cooling to the room temperature.

10. The method according to claim 9, wherein the annealing process is performed at a constant temperature of 150° C. for 1 hour.

11. The method according to claim 1, wherein the annealing process is performed after the step of forming the transparent conductive layer.

12. The method according to claim 11, wherein the annealing process is performed before the step of forming the protection layer.

13. The method according to claim 1, wherein the conductive composition further comprises tannic acid, gallic acid or a combination thereof.
